(19) United States
(12) Patent Application Publication
(10) Pub. No.: US 2026/0176007 A1
(43) Pub. Date: Jun. 25, 2026

(54) LAUNCHER AND LIFTING SYSTEM INCLUDING THE SAME

(71) Applicant: NEARTHLAB INC., Seoul (KR)

(72) Inventors: Youngsuk Chung, Seoul (KR); Jeongsan Seo, Seoul (KR); Byoungkyu Son, Seoul (KR); Yeongryeol Choi, Seoul (KR); Minsoo Shin, Seoul (KR)

(21) Appl. No.: 19/343,545

(22) Filed: Sep. 29, 2025

(30) Foreign Application Priority Data
Dec. 19, 2024 (KR) 10-2024-0191476
Feb. 4, 2025 (KR) 10-2025-0013696

(51) Int. Cl. B64U 70/70; B64U 70/80

(52) U.S. Cl. CPC B64U 70/70; B64U 70/80

(57) ABSTRACT

The present disclosure relates to a launcher and a lifting system comprising the launcher.

According to some aspects of the disclosure, The launcher comprises a body and a communication interface embedded in the body and configured to communicate with the moving object, wherein, when the moving object is present inside the launcher, the communication interface is configured to control power supply to be blocked for some of a plurality of components included in the moving object by delivering a power control signal to a wireless switch included in the moving object.

### CROSS-REFERENCE TO RELATED APPLICATION

This application claims priority under 35 U.S.C § 119 to Korean Patent Application No. 10-2025-0013696 filed on Feb. 4, 2025, and claims priority to Korean Patent Application No. 10-2024-0191476 filed on Dec. 12, 2024, in the Korean Intellectual Property Office, the entire contents of both of which are hereby incorporated by reference.

### TECHNICAL FIELD

The disclosure relates to a launcher and a lifting system including the launcher.

### BACKGROUND

The material described in this section merely provides background information for the present embodiment and does not constitute prior art.

Recently, drones have been developed for inspecting structures (e.g., a wind power generator) or tracking and/or shooting down targets (e.g., illegal drones), and with recent technological advancements, drones are being commercialized in various industrial fields.

As drone technology advances, there are attempts to incorporate automated methods into drone operations. At this time, a launcher capable of stably supporting the takeoff and landing of a drone and a lifting system using the launcher may be used for automated drone operation.

### SUMMARY

It is an object of the present disclosure to provide a launcher, and a lifting system including the launcher capable of minimizing power consumption while a drone is waiting on the launcher. More specifically, it is an object of the present disclosure to provide a launcher, and a lifting system including the launcher capable achieving optimization of power consumption when a moving object is built into the launcher.

It is an object of the present disclosure to provide a launcher, and a lifting system including the launcher capable of supporting a stable initial rise of a moving object when taking off from the launcher. More specifically, it is an object of the present disclosure to provide a launcher, and a lifting system including the launcher capable of supporting stable takeoff of a drone through various lifting mechanisms (such as a guide and wheel, an electric actuator, and a method utilizing the power of a propeller).

The objects of the present disclosure are not limited to the objects mentioned above, and other objects and advantages of the present disclosure which are not mentioned may be understood by the following description and will be more clearly understood by the embodiments of the present disclosure. Furthermore, it will be readily apparent that the objects and advantages of the present disclosure may be achieved by the means and combinations thereof set forth in the claims.

According to some aspects of the disclosure, A launcher for lifting a moving object comprises a body and a communication interface embedded in the body and configured to communicate with the moving object, wherein, when the moving object is present inside the launcher, the communication interface is configured to control power supply to be blocked for some of a plurality of components included in the moving object by delivering a power control signal to a wireless switch included in the moving object.

Additionally, wherein the moving object comprises an electronic speed control (ESC) for controlling a driving part comprising a motor or a propeller, and wherein the communication interface provides a power cut-off signal, which turns off the wireless switch, to components other than the ESC.

Additionally, wherein the moving object comprises a mission management unit (MMU), a flight control unit (FCU), a battery eliminator circuit (BEC), and a modem, and wherein the communication interface provides a power cut-off signal, which turns off the wireless switch, to at least one of the MMU, FCU, BEC, and modem.

Additionally, wherein the communication interface provides a power supply signal that turns on the wireless switch when the moving object is lifted from the launcher and is launched from the launcher.

Additionally, wherein the body comprises a bottom of body and a side of body, and wherein the launcher comprise: a supporting part configured to be in contact with a lower side of the moving object to support the moving object from below, and a lifting control part configured to lift the moving object by controlling at least one of the moving object and the supporting part.

Additionally, wherein the supporting part comprises a protrusion part configured to fix the moving object to the supporting part by being inserted into a groove formed on a bottom of the moving object.

Additionally, wherein the launcher further comprises a guide part configured to guide the supporting part to move vertically inside the launcher by being structurally connected to the supporting part.

Additionally, wherein the guide part comprises an attachment part that is attached to at least one of a bottom of the body of the launcher and a side of the body of the launcher.

Additionally, wherein the supporting part comprises a connect part that is structurally connected to the guide part.

Additionally, wherein the lifting control part is configured to lift the moving object by controlling a wire structurally connected to the supporting part to move the supporting part along the guide part, wherein the connect part comprises a wheel that is rollable along the guide part, and wherein the supporting part further comprises a wire receptor configured to accommodate the wire.

Additionally, wherein the wheel comprises a plurality of wheels comprising a first wheel and a second wheel, and wherein the wire receptor comprises a plurality of wire receptors comprising a first wire receptor and a second wire receptor.

Additionally, wherein each of the first wheel, the second wheel, the first wire receptor, and the second wire receptor is disposed at a different position on the supporting part.

Additionally, wherein the first wheel and the second wheel are disposed at positions facing each other on the supporting part, wherein the first wire receptor and the second wire receptor are disposed at positions facing each other on the supporting part, and wherein the plurality of wheels and the plurality of wire receptors are alternately arranged at predefined angles with respect to a center of the supporting part.

Additionally, wherein the lifting control part generates thrust in the moving object by providing a flight control signal to the moving object and lifts the moving object by causing the supporting part in contact with the moving object to move along the guide part, and wherein the connect part comprises a connector that is structurally connected to the guide part.

Additionally, wherein the connector comprises a locker that locks the moving object to the supporting part by being structurally connected to the moving object.

Additionally, wherein the guide part comprises a blocking part that prevents the supporting part from ascending beyond a predefined height, and wherein, when the supporting part collides with the blocking part, the locker releases the locking of the moving object.

Additionally, wherein the launcher further comprises a position sensor configured to determine a position of the moving object inside the launcher, and wherein the lifting control part controls the locker to release the locking based on the position of the moving object determined by the position sensor.

Additionally, wherein the lifting control part lifts the moving object by applying an external force to the supporting part itself to change the position of the supporting part.

Additionally, wherein the lifting control part comprises an actuator that changes the position of the supporting part in a direction of at least one axis.

A launcher, and a lifting system including the same according to some embodiments of the present disclosure may minimize power consumption while a drone is waiting in the launcher. For example, a launcher, and a lifting system including the same according to some embodiments of the present disclosure may achieve optimization of power consumption by cutting off power to at least some of the plurality of components included in the moving object while the moving object is built in the launcher.

In addition, a launcher, and a lifting system including the same according to some embodiments of the present disclosure may secure the stability of a wireless switch by continuously supplying power to components requiring high voltage, such as ESC, while efficiently managing power by cutting off power to BEC, FCU, MMU, Modem, etc.

In addition, a launcher, and a lifting system including the same according to some embodiments of the present disclosure may support a stable initial rise of a mobile body when the moving object takes off from the launcher. For example, a launcher, and a lifting system including the same according to some embodiments of the present disclosure may support a stable takeoff of a drone through various lifting mechanisms (a method using the power of a guide and wheels, an electric actuator, and a propeller, etc.).

In addition, a launcher, and a lifting system including the same according to some embodiments of the present disclosure may provide a safe operating environment for a drone through various sensors and control systems, such as a temperature sensor, a drone position sensor, and a cooling fan.

In addition, a launcher, and a lifting system including the same according to some embodiments of the present disclosure may provide a flexible system capable of being expanded to various sizes from 1×1 to 2×2 or more through a modular design of the launcher.

In addition to the foregoing description, specific effects of the present disclosure will be stated together while describing specific details for implementing the present disclosure below.

### BRIEF DESCRIPTION OF THE DRAWINGS

FIG. 1 illustrates a lifting system according to some embodiments of the present disclosure.

FIG. 2 is a block diagram of a moving object included in a lifting system according to some embodiments of the present disclosure.

FIGS. 3 and 4 illustrate types of launchers according to some embodiments of the present disclosure.

FIG. 5 is a diagram illustrating a sub-launcher and a fan included in a launcher according to some embodiments of the present disclosure.

FIG. 6 is a diagram illustrating the operation of a fan according to some embodiments of the present disclosure.

FIGS. 7 to 10 are diagrams for illustrating an auxiliary line included in the launcher according to some embodiments of the present disclosure.

FIG. 11 is a block diagram of a launcher according to several embodiments of the present disclosure.

FIGS. 12 to 18 are diagrams illustrating an embodiment in which a lifting control part (LC) lifts a moving object (OJ) using a wire, according to some embodiments of the present disclosure.

FIGS. 19 to 21 are diagrams for explaining embodiments in which the lifting control part (LC) lifts the moving object by transmitting a flight control signal to the moving object to control the generation of thrust of the moving object, according to several embodiments of the present disclosure.

FIG. 22 is a diagram for illustrating an embodiment in which the lifting control part according to some embodiments of the present disclosure lifts the moving object by pressing the supporting part in a predetermined axial direction.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

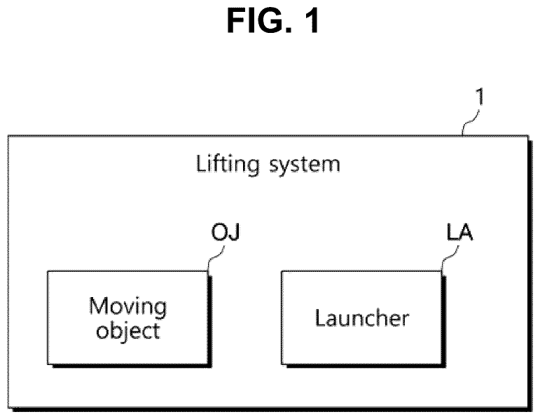

Hereinafter, a launcher, and a lifting system including the same according to some embodiments of the present disclosure will be described with reference to FIGS. 1 to 22.

FIG. 1 illustrates a lifting system according to some embodiments of the present disclosure.

Referring to FIG. 1, a lifting system 1 may include a moving object (hereinafter, may also be referred to as “OJ”) and a launcher (hereinafter, may also be referred to as “LA”). However, the embodiments of the present disclosure are not limited to this example, and it is obvious that the lifting system 1 may include other configurations not shown in FIG. 1.

The moving object (OJ) may include an object capable of moving along land, sea, or air. For example, a moving object (OJ) may include a flying vehicle. In this case, the flying vehicle may include all types of flight-capable bodies, such as drones, unmanned aerial vehicles (UAV), unmanned aerial mobility (UAM), aircraft, and helicopters. Hereinafter, for convenience of explanation, it is assumed that the moving object (OJ) is a flying vehicle.

The moving object (OJ) may include detailed configurations for movement and flight. For example, the moving object (OJ) may include a sensor, a camera, a memory, a driving device (such as a motor or a propeller), a communication device, and a processor.

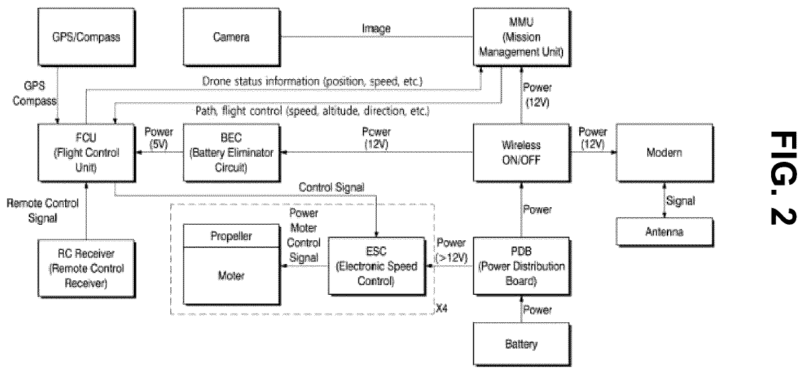

Hereinafter, with reference to FIG. 2, each detailed configuration included in the moving object (OJ) according to some embodiments of the present disclosure will be described in detail.

FIG. 2 is a block diagram of a moving object included in a lifting system according to some embodiments of the present disclosure.

Referring to FIGS. 1 and 2, the moving object (OJ) may include a sensor (GPS/compass), a camera, a driving device (such as a motor and a propeller), a communication device, a battery module (battery, PDB), a modem, and a processor. At this time, the processor may include components such as an electronic speed control (ESC), a mission management unit (MMU), a flight control unit (FCU), and a battery eliminator circuit (BEC).

The sensor (GPS/Compass) detects various types of information necessary for the operation of the moving object OJ (e.g., flight, imaging), such as the moving object OJ itself, the surrounding environment of the moving object OJ, identification of the target object 20, and the distance between the moving object OJ and the target object 20.

For example, the sensor (GPS/Compass) may include a global positioning system (GPS) sensor and a geomagnetic sensor (compass sensor). The global positioning system (GPS) sensor may calculate the current coordinates (x, y, z) of the moving object OJ using GPS signals. The geomagnetic sensor may detect geomagnetic information about the moving object OJ. However, the embodiments of the present disclosure are not limited thereto, and the sensor (GPS/Compass) may further include a gyro sensor, a barometer, an ultrasonic sensor, an acceleration sensor, a proximity sensor, a LiDAR sensor, a radar sensor, and/or an attitude and heading reference system (AHSR).

The camera may capture the target object under the control of the processor. For example, the moving object OJ may include at least one camera, and may include a low-resolution camera and/or a high-resolution camera. The camera may be coupled with a gimbal capable of adjusting angles. Accordingly, the camera may have its shooting angle adjusted by the gimbal. However, the embodiments of the present disclosure are not limited thereto, and the moving object OJ may include, together with or instead of the camera, an ultrasonic sensor, a proximity sensor, a LiDAR sensor, and/or a radar sensor for detecting the target object.

The driving device may control the movement of the moving object OJ at a speed and in a direction according to the instructions of the processor. In this case, the driving device may include a motor and a propeller. For example, the driving device may be controlled by the processor, and accordingly, the rotational speed and direction of the propeller connected to the motor may be controlled.

The communication device performs data communication between the respective components included in the moving object OJ or between the moving object OJ and an external device. For example, the communication device may communicate with a controller, a server, a station, and/or a launcher (LA) using various communication methods such as infrared communication, radio frequency (RF) communication, Wi-Fi communication, ZigBee communication, Bluetooth communication, laser communication, ultra-wideband (UWB) communication, LTE, 5G, 6G, or wireless LAN. However, the communication method employed by the communication device 150 is not limited to the aforementioned examples. For example, the communication device may be connected to a power distribution board (PDB) and may include a power distribution communicator responsible for power distribution among the components included in the moving object OJ and/or a remote control receiver (RC receiver) for receiving control signals from an external source.

The processor may process instructions of a computer program by performing basic arithmetic, logic, and input/output operations. Here, the instructions may be provided from a memory inside the moving object OJ or from an external device. The instructions may also be referred to as the above-mentioned “instruction.” In this case, the processor may be operatively connected to the memory in order to perform overall functions of the moving object OJ. In addition, the processor may control the overall operations of other components included in the moving object OJ.

As several examples, the processor may include an electronic speed control (ESC), a mission management unit (MMU), a flight control unit (FCU), and a battery eliminator circuit (BEC).

The mission management unit (MMU) may be a processor that performs onboard computation. For example, the mission management unit (MMU) may be a processor that receives drone status information (e.g., position, speed, etc.) from the flight control unit (FCU), receives image data from the camera, and calculates a flight method, flight path, and the like based on the received drone status information and image data.

The flight control unit (FCU) may be a processor for flight control. For example, the flight control unit (FCU) may receive information for path and/or flight control (e.g., speed, altitude, direction, etc.) as described above from the mission management unit (MMU), and may control the electronic speed control (ESC) based on the received information. The battery eliminator circuit (BEC) may be a component that controls power supply to the flight control unit (FCU).

The electronic speed control (ESC) may be a processor that controls the driving device (motor or propeller) under the control of the flight control unit (FCU). In other words, the electronic speed control (ESC) may be a component that controls the operation of the motor and/or propeller included in the driving device.

The battery module may include a battery and a power distribution board (PDB). The power distribution board (PDB) may distribute power received from the battery to other components.

For example, the power distribution board (PDB) may supply power received from the battery to the electronic speed control (ESC). In this case, the power distribution board (PDB) may continuously supply power to the electronic speed control (ESC) regardless of whether the moving object OJ has taken off. In other words, the power distribution board (PDB) may supply power to the electronic speed control (ESC) in all situations, including when the moving object (OJ) is performing lifting and takeoff for flight, as well as when the moving object (OJ) is on standby on the launcher (LA).

As another example, the power distribution board (PDB) may distribute the power received from the battery to each component included in the moving object (OJ) through a wireless power supply (wireless ON/OFF) method. In this case, the power distribution board (PDB) may perform power distribution through a wireless power supply (wireless ON/OFF) method using a wireless switch. The wireless switch may be a component included in the power distribution board (PDB) or may be a separate component located outside the power distribution board (PDB). In this case, the components to which the power distribution board (PDB) supplies power through the wireless power supply (wireless ON/OFF) method may include an MMU, an FCU, a BEC, a modem, and the like, as illustrated in FIG. 2. However, the embodiment of the present disclosure is not limited thereto.

Meanwhile, when supplying power through such a wireless power supply (wireless ON/OFF) method, the power distribution board (PDB) may perform the power supply based on a power control signal applied from the outside. In this case, the power control signal may include a signal for controlling the wireless switch to be turned ON or OFF. In other words, the power control signal may include a power supply signal for turning the wireless switch ON and a power cutoff signal for turning the wireless switch OFF.

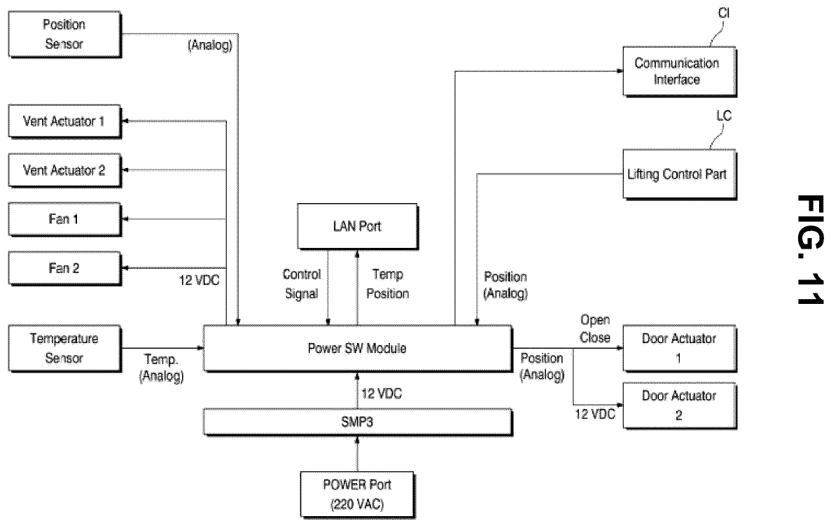

As one embodiment, when the moving object (OJ) is on standby on the launcher (LA), the power distribution board (PDB) may receive a power cutoff signal from a communication interface (CI in FIG. 11) included in the launcher (LA) and/or an external ground control system (GCS), and may control the wireless switch to be turned OFF according to the received power cutoff signal. That is, when the moving object (OJ) is on standby within the launcher (LA), a power distribution board (PDB) may supply power to the ESC included in the moving object (OJ), but, in contrast, may block power supply to components such as the MMU, FCU, BEC, and modem that receive power via the wireless switch. This is because, in the case of high-speed drones, the ESC requires a high voltage, which may place a strain on the wireless switch. Therefore, in the case of the ESC, power is continuously supplied to ensure durability, whereas power to components such as the MMU, FCU, BEC, and modem, which do not require such characteristics, is cut off. As a result, while the moving object (OJ) is on standby within the launcher (LA), power consumption may be minimized without compromising durability.

In another embodiment, when the moving object (OJ) is lifted from the launcher (LA) for flight and receives a launch signal for takeoff, the power distribution board (PDB) may receive a power supply signal from the communication interface (CI in FIG. 11) included in the launcher (LA) and/or from an external ground control system (GCS), and may control the wireless switch to turn on (ON) according to the received power supply signal. That is, in a situation where the moving object (OJ) has received a launch signal, the power distribution board (PDB) may supply power not only to the ESC included in the moving object (OJ), but also to the MMU, FCU, BEC, and modem, which receive power through the wireless switch.

Referring again to FIG. 1, the launcher (LA) is a device that assists in the launch of the moving object (OJ). In other words, the moving object (OJ) may be launched externally while being stored in the launcher (LA).

Power may be supplied to the launcher (LA). For example, the launcher (LA) may include an actuator, a fan that controls the inflow and outflow of air through a flow path, a communication interface that performs wired or wireless communication with the moving object (OJ) or an external ground control system (GCS), and sensors (e.g., position sensor, temperature sensor). Power may be supplied to such components including the actuator, fan, communication interface, and sensors.

For example, the launcher (LA) may include a car launcher, a flight launcher, and a ground launcher. The car launcher is a device in the form of a car that assists in the launch of the moving object (OJ), the flight launcher is a device in the form of a flying vehicle that assists in the launch of the moving object (OJ), and the ground launcher is a device attached to or deployed on the ground that assists in the launch of the moving object (OJ). However, the embodiments of the present disclosure are not limited thereto, and the moving object (OJ) in the present disclosure may be launched manually by a user.

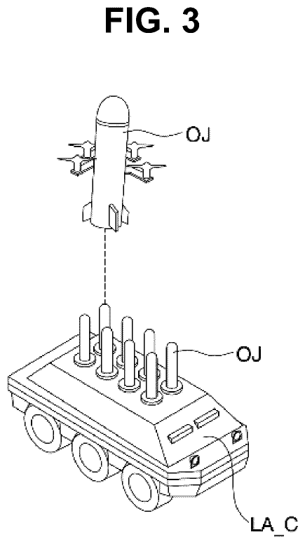

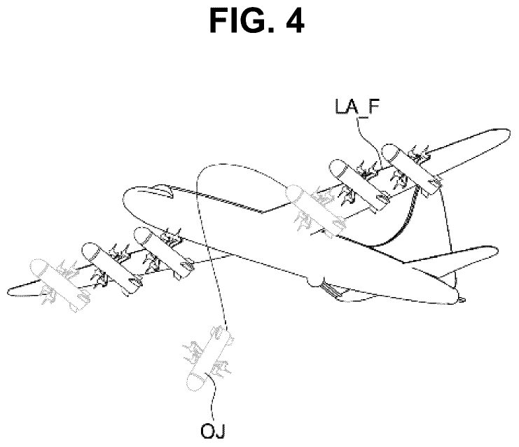

Hereinafter, the launcher (LA) will be described in more detail with reference to FIGS. 3 and 4.

FIGS. 3 and 4 illustrate types of launchers according to some embodiments of the present disclosure.

Referring to FIG. 1, FIG. 3, and FIG. 4, a launcher (LA) according to several embodiments of the present disclosure may include a car launcher (LA_C) and/or a flight launcher (LA_F).

In some examples, as shown in FIG. 3, a launcher (LA) according to several embodiments of the present disclosure may include a car launcher (LA_C). The car launcher (LA_C) may be a device in the form of a car that assists in launching the moving object (OJ). In this case, the car launcher (LA_C) may include a main body including a wheel that contacts the ground, and a receptor disposed on an upper or side surface of the main body to accommodate the moving object (OJ).

In other examples, as illustrated in FIG. 4, the launcher (LA) according to some embodiments of the present disclosure may include a flight launcher (LA_F). The flight launcher (LA_F) may be a device in the form of a flying vehicle (e.g., an airplane) that assists in launching the moving object OJ. In this case, the flight launcher (LA_F) may include a main body that includes components such as a propeller for flying, and a receptor disposed on one surface of the main body for accommodating the moving object OJ.

Referring again to FIG. 1, the launcher (LA) may be in a modular form in which a plurality of individual launchers, each of which may accommodate and contain the moving object (OJ), are combined. In other words, the launcher (LA) may include a plurality of individual launchers, and each individual launcher may accommodate at least one moving object (OJ).

Additionally, a fan that allows air to flow in and out may be formed in the launcher (LA).

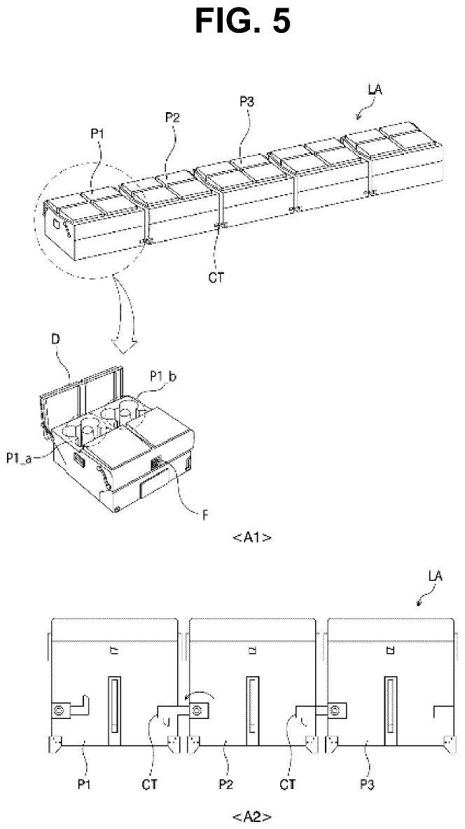

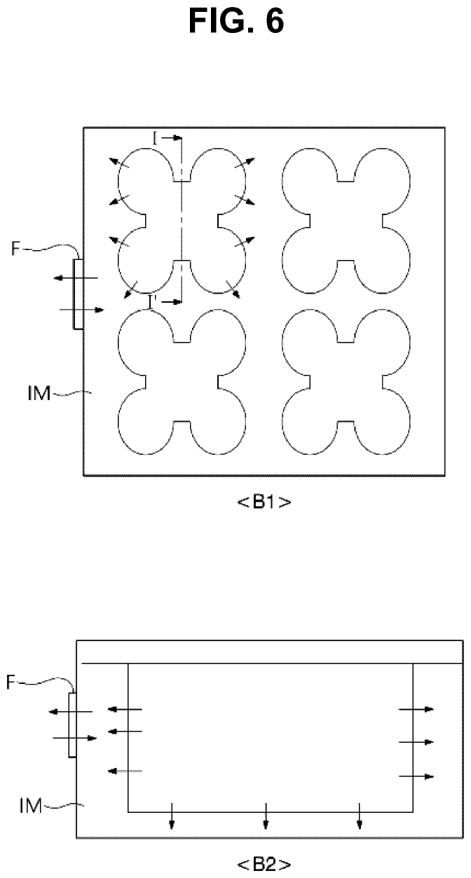

Hereinafter, with reference to FIGS. 5 and 6, a description will be given of the individual launchers included in the launcher (LA), a connection connecting the launchers, and the fan included in the launcher (LA).

FIG. 5 is a diagram illustrating a sub-launcher and a fan included in a launcher according to some embodiments of the present disclosure. FIG. 6 is a diagram illustrating the operation of a fan according to some embodiments of the present disclosure. Specifically, <A1> of FIG. 5 shows a perspective view of the launcher (LA) according to some embodiments of the present disclosure and an enlarged view of an individual launcher (Part of Launcher, hereinafter also referred to as “P”) included in the launcher (LA), and <A2> of FIG. 5 shows a front view of the launcher (LA) according to some embodiments of the present disclosure. <B1> of FIG. 6 illustrates a top view of the air intake and exhaust process in the launcher (LA) according to some embodiments of the present disclosure, and <B2> of FIG. 6 illustrates a front view of the air intake and exhaust process in the launcher (LA) according to some embodiments of the present disclosure.

Here, a ground launcher is shown as a type of launcher (LA) in FIGS. 5 and 6. The ground launcher may be configured to be placed on the ground and may serve to assist in the launch of the moving object (OJ). In this case, the ground launcher may include a main body having a grounding surface that comes into contact with the ground, and a receptor disposed on an upper surface or a side surface of the main body to accommodate the moving object (OJ).

Referring to FIGS. 1, 5, and 6, the launcher (LA) according to some embodiments of the present disclosure may be in a modular form in which a plurality of individual launchers (P1 to P3) are combined. In other words, the launcher (LA) may include a plurality of individual launchers (P1 to P3), and each individual launcher (P) may accommodate the moving object (OJ). That is, the launcher (LA) according to some embodiments of the present disclosure may be in a combined or assembled form in which a plurality of individual launchers (P1 to P3) are joined together.

In this case, the individual launchers (P1 to P3) may include a fastening structure (e.g., rings, grooves, etc.) that allows them to be fastened to each other. In other words, the launcher (LA) may include a connection (hereinafter, also referred to as “CT”) for connecting the individual launchers (P1 to P3) to each other. Here, the connection (CT), as illustrated in <B2> of FIG. 5, may be rotated while being attached to one of the individual launchers (e.g., P2), and thereby engage with a groove formed in another individual launcher (e.g., P1), so as to connect the individual launchers (P1 to P3).

Such individual launchers (P1 to P3) may include sub-launchers. As an example, FIG. 5 illustrates a first sub-launcher (P1_a) and a second sub-launcher (P1_b) included in the first individual launcher (P1). For convenience of explanation, FIG. 5 illustrates the first individual launcher (P1) as including a total of four sub-launchers, but the embodiment of the present disclosure is not limited thereto.

Here, the launcher (LA) may include a fan (hereinafter, also referred to as “F”). The fan (F) may control the inflow and outflow of air through a flow path formed in the inner part (hereinafter, also referred to as “IP”), thereby cooling the interior of the launcher (LA) and minimizing the influence of lift on the moving object (OJ). In other words, the fan (F) may perform an air control process through the flow path formed in the inner part (IP). Here, the inner part (IP) may be formed, configured, and/or manufactured using a material for forming the flow path, such as expanded polypropylene (EPP) foam, but the embodiment of the present disclosure is not limited thereto. In another aspect, the inner part (IP) may also serve to protect the launcher (LA) from external impacts.

<B1> and <B2> of FIG. 6 illustrate the process of air inflow and outflow controlled by the fan (F) through the flow path formed in the inner part (IP), but the embodiments of the present disclosure are not limited thereto.

Additionally, the launcher (LA) may further include an actuator for opening and closing the door (D) under the control of the door (D) and a ground control system (GCS). In FIG. 5, for convenience of explanation, the door (D) is illustrated as being formed on the upper surface of each individual launcher (P1 to P3), but the embodiment of the present disclosure is not limited thereto, and the door (D) may also be disposed and formed on the side, front, or other portions of each individual launcher (P1 to P3). Additionally, other components included in the launcher (LA), such as an actuator, a communication module, and sensors, may be embedded inside each individual launcher (P1 to P3).

Referring again to FIG. 1, the launcher (LA) may include an auxiliary line that assists in the takeoff of the moving object (OJ). In other words, the launcher (LA) may include an auxiliary line that supports, sustains, and assists the moving object (OJ) during takeoff so that the moving object (OJ) may perform the takeoff process in a stable manner.

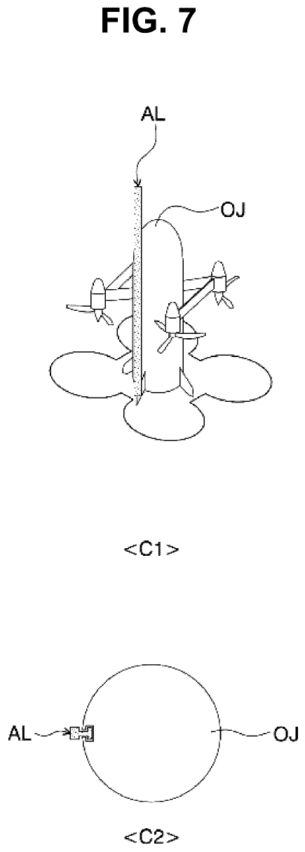

Hereinafter, the auxiliary line included in the launcher (LA) will be described in detail with reference to FIGS. 7 to 10.

FIGS. 7 to 10 are diagrams for illustrating an auxiliary line included in the launcher according to some embodiments of the present disclosure.

Referring to FIG. 1 and FIGS. 7 to 10, the launcher (LA) according to several embodiments of the present disclosure may include an auxiliary line (AL) that assists the takeoff of the moving object (OJ). Here, the auxiliary line (AL) may be included in the car launcher or the flight launcher described above with reference to FIGS. 3 and 4, or may be included in the ground launcher described above with reference to FIGS. 5 and 6.

The moving object (OJ) may experience significant shaking during the takeoff process until it reaches the critical speed at takeoff. Accordingly, the launcher (LA) according to several embodiments of the present disclosure may include an auxiliary line (AL) that assists the initial takeoff of the moving object (OJ), thereby supporting a safe and accurate takeoff of the moving object (OJ).

As one example, as shown in FIG. 7, the auxiliary line (AL) included in the launcher (LA) according to several embodiments of the present disclosure may be in the form of a pillar. <C1> of FIG. 7 is a perspective view showing the combination of the pillar-type auxiliary line (AL) and the moving object (OJ), and <C2> of FIG. 7 is a top view showing the combination of the pillar-type auxiliary line (AL) and the moving object (OJ). In <C1> and <C2> of FIG. 7, for convenience of explanation, the moving object (OJ) is shown coupled to a single auxiliary line (AL). However, the embodiments of the present disclosure are not limited thereto, and the auxiliary line (AL) may include a plurality of pillar-type structures coupled to different positions of the moving object (OJ). Here, the moving object (OJ) may include a groove for coupling with the auxiliary line (AL), as shown in <C2> of FIG. 7. Meanwhile, the height of the auxiliary line (AL) may be greater than the height of the moving object (OJ). However, the height of the auxiliary line (AL) does not necessarily have to be greater than the height of the moving object (OJ).

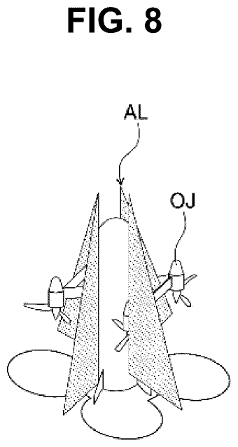

In other examples, as shown in FIG. 8, the auxiliary line (AL) included in the launcher (LA) according to several embodiments of the present disclosure may be in the form of a triangle. In FIG. 8, as one example, the moving object (OJ) is shown coupled to four triangular auxiliary lines (AL). However, the embodiments of the present disclosure are not limited thereto, and the number of triangular auxiliary lines (AL) may be freely varied. Here, the moving object (OJ) may include a groove for coupling with the triangular auxiliary line (AL). Meanwhile, the height of the auxiliary line (AL) may be greater than the height of the moving object (OJ). However, the height of the auxiliary line (AL) does not necessarily have to be greater than the height of the moving object (OJ).

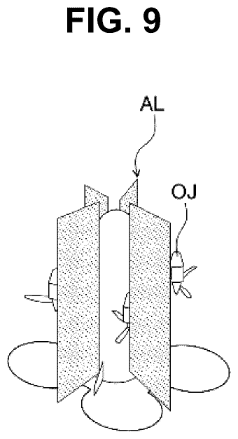

In still other examples, as shown in FIG. 9, the auxiliary line (AL) included in the launcher (LA) according to several embodiments of the present disclosure may be in the form of a quadrangle. In FIG. 9, as one example, the moving object (OJ) is shown coupled to four quadrangular auxiliary lines (AL). However, the embodiments of the present disclosure are not limited thereto, and the number of quadrangular auxiliary lines (AL) may be freely varied. Here, the moving object (OJ) may include a groove for coupling with the quadrangular auxiliary line (AL). Meanwhile, the height of the auxiliary line (AL) may be greater than the height of the moving object (OJ). However, the height of the auxiliary line (AL) does not necessarily have to be greater than the height of the moving object (OJ).

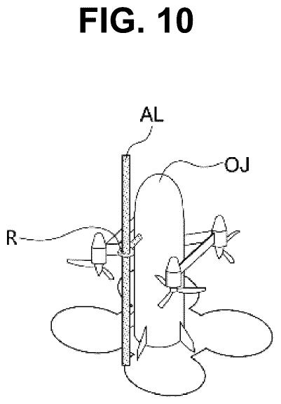

In still other examples, as shown in FIG. 10, the auxiliary line (AL) included in the launcher (LA) according to several embodiments of the present disclosure may include a ring (R) that assists the connection with the moving object (OJ). Here, the ring (R) may serve to physically connect the auxiliary line (AL) and the moving object (OJ). In FIG. 10, as one example, a case where the number of rings (R) is one is shown. However, the embodiments of the present disclosure are not limited thereto, and the number of rings (R) included in the auxiliary line (AL) may be freely varied.

Referring again to FIG. 1, as described above, the moving object (OJ) may be launched outward while being stored in the launcher (LA). To this end, the launcher (LA) may lift the moving object (OJ). In other words, the launcher (LA) may change the position of the moving object (OJ) within the launcher (LA) to enable the takeoff of the moving object (OJ).

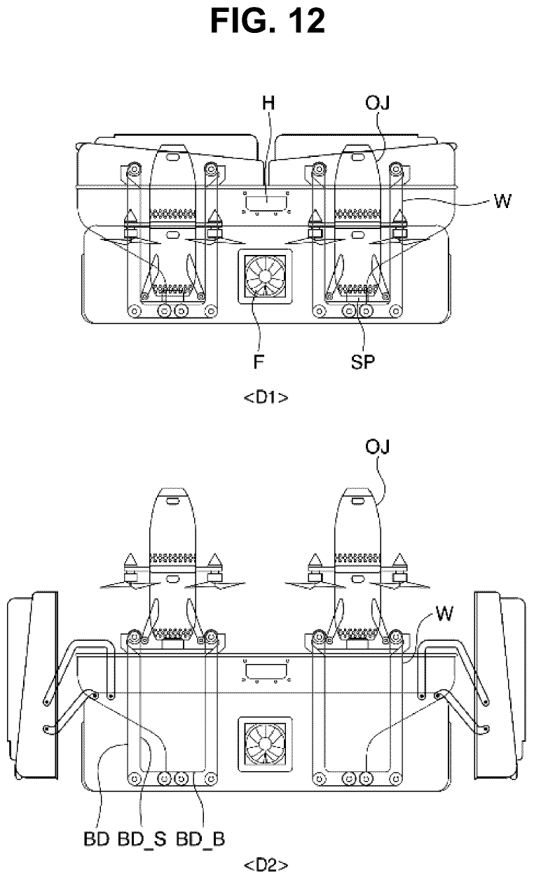

Hereinafter, with reference to FIGS. 11 and 12, a detailed description will be given of the detailed configuration of the launcher (LA) and the lifting process of the moving object (OJ) through the launcher.

FIG. 11 is a block diagram of a launcher according to several embodiments of the present disclosure.

Referring to FIGS. 1, 2, and 11, the launcher (LA) according to several embodiments of the present disclosure may include an actuator, fans (F1, F2), a sensor, a LAN port for communication with an external ground control system (GCS), a communication interface (CI) for controlling power supply to the moving object (OJ), a processor (Power S/W Module), an SMPS, and a lifting control part (LC).

The actuator may be a component that provides power for movement, opening and closing, or operation within the launcher (LA). For example, the actuator may include a door actuator for opening and closing the door D described in FIG. 5, and a vent actuator for controlling the inflow and outflow of air by opening and closing the cover of the fan F described in FIG. 6. In FIG. 11, for convenience of explanation, the launcher (LA) is illustrated as including two door actuators and two vent actuators, respectively. However, this is merely for illustrative purposes, and the embodiments of the present disclosure are not limited thereto. Here, the plurality of door actuators may operate simultaneously or may operate independently of each other. Similarly, the plurality of vent actuators may also operate simultaneously or may operate independently of each other.

Additionally, the actuator may further include a wire actuator and a supporting part actuator, which are controlled by a lifting control part (LC) as will be described below.

The fans F1 and F2 may refer to the same configuration as the fan F described in FIG. 6. In FIG. 11, for convenience of explanation, the launcher (LA) is illustrated as including a first fan (F1) and a second fan (F2). However, this is merely for illustrative purposes, and the number of fans (F) included in the launcher (LA) is not limited thereto.

The sensor may be configured to sense the environment inside the launcher (LA). For example, the sensor may include a position sensor and a temperature sensor. The position sensor may identify the location of the moving object (OJ) within the launcher (LA) to determine whether the moving object (OJ) is waiting in the correct position, and the temperature sensor may determine the internal temperature of the launcher (LA). However, the embodiments of the present disclosure are not limited thereto, and it is apparent that the sensor may include various other types of functional sensors.

The LAN port may perform wired or wireless communication with an external ground control system (GCS). For example, the LAN port may transmit data sensed by the sensor, for example, temperature or the position of the moving object (OJ), to the ground control system (GCS), and in response, may receive control signals from the ground control system (GCS) to control these parameters.

The SMPS may convert the power (220 VAC) received from the power port into converted power (12 VDC), and then deliver it to the processor.

The processor may perform data transmission and reception with the ground control system (GCS) through the LAN port. For example, the processor may receive control signals from the ground control system (GCS) through a LAN port, or may transmit information such as temperature, the position of the moving object (OJ), the open/close state of the door (D), the open/close state of the fan (F) cover, and the lifting result of the moving object (OJ), to the ground control system (GCS) through the LAN port.

The communication interface (CI) may perform wireless communication with the moving object (OJ) to control power supply to the moving object (OJ). In some examples, the communication interface (CI) may control wireless power supply (wireless ON/OFF) through the wireless switch of the moving object (OJ) by transmitting a power control signal to a power distribution board (PDB) or a wireless switch included in the moving object (OJ). Here, the power control signal may include a signal for controlling the wireless switch to turn ON or OFF. In other words, the power control signal may include a power supply signal that turns the wireless switch ON and a power cut-off signal that turns the wireless switch OFF. Here, as illustrated in FIG. 2, the configuration in which the power distribution board (PDB) supplies power through a wireless power supply (Wireless ON/OFF) scheme may include a mission management unit (MMU), a flight control unit (FCU), a battery eliminator circuit (BEC), a modem, and the like, but the present disclosure is not limited thereto. That is, in the case of the electronic speed controller (ESC), power may be continuously supplied from the power distribution board (PDB) regardless of the power control of the communication interface (CI).

Such a communication interface (CI) may transmit a power control signal based on the situation, position, or the like of the moving object (OJ). For example, the communication interface (CI) may control the power supply to each component of the moving object (OJ), such as the mission management unit (MMU), flight control unit (FCU), battery eliminator circuit (BEC), and modem, through wireless communication, based on whether the moving object (OJ) is waiting inside the launcher (OJ).

As one embodiment, when the moving object (OJ) is waiting in the launcher (LA), the communication interface (CI) may transmit a power cutoff signal to the power distribution board (PDB), and in this case, the power distribution board (PDB) may control the wireless switch to OFF according to the received power cutoff signal. That is, when the moving object (OJ) is on standby within the launcher (LA), power supply to components such as the mission management unit (MMU), flight control unit (FCU), battery eliminator circuit (BEC), and modem, which receive power through the wireless switch, may be blocked, unlike the electronic speed controller (ESC) that is not controlled via the wireless switch. This is because, in the case of high-speed drones, the electronic speed controller (ESC) requires a high voltage, which may place a strain on the wireless switch. Therefore, in the case of the ESC, power is continuously supplied to ensure durability, whereas power supply to components such as the MMU, FCU, BEC, and modem, which do not require such characteristics, is blocked. As a result, while the moving object (OJ) is on standby in the launcher (LA), durability is maintained and power consumption may be minimized.

In another embodiment, when the moving object (OJ) is lifted from the launcher (LA) for flight and receives a launch signal for takeoff, the communication interface (CI) may transmit a power supply signal to the power distribution board (PDB). Here, the power distribution board (PDB) may control the wireless switch to be turned on (ON) according to the received power supply signal. That is, in a situation where the moving object (OJ) has received the launch signal, the power distribution board (PDB) may supply power not only to the ESC included in the moving object (OJ), but also to the MMU, FCU, BEC, modem, and the like that receive power through the wireless switch.

However, the embodiments of the present disclosure are not limited thereto, and the above-described power control operation of the communication interface (CI) may be controlled by an external ground control system (GCS). In other words, the power control signal received by the power distribution board (PDB) may be received not from the communication interface (CI), but from an external ground control system (GCS).

The lifting control part (LC) may lift the moving object (OJ). In other words, the lifting control part (LC) may change the position of the moving object (OJ) within the launcher (LA) to enable the takeoff of the moving object (OJ). For example, the lifting control part (LC) may control at least one of the supporting parts (SP in FIG. 12) included in the moving object (OJ) and the launcher (LA), thereby lifting the moving object (OJ).

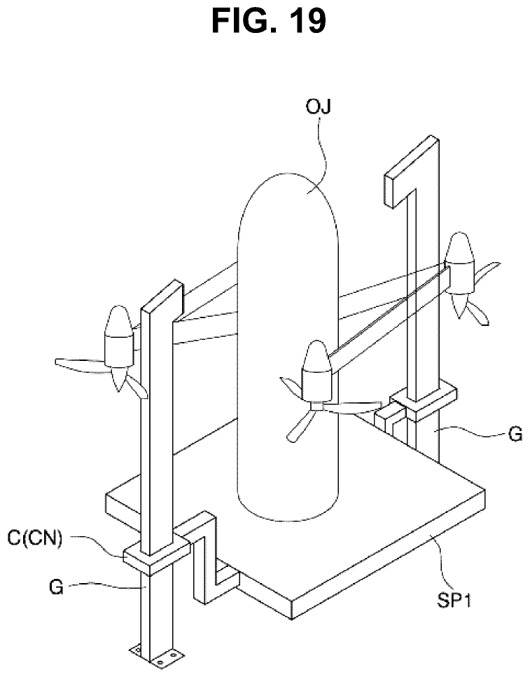

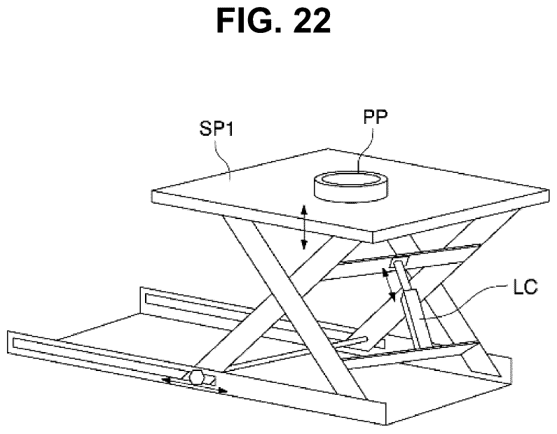

Hereinafter, with additional reference to FIGS. 12 to 22, the operation of the lifting control part (LC) will be described. More specifically, FIGS. 12 to 18 describe a first embodiment in which the lifting control part (LC) lifts the moving object (OJ) via a wire (W in FIG. 12), FIGS. 19 to 21 describe a second embodiment in which the lifting control part (LC) lifts the moving object (OJ) using thrust of the moving object (OJ), and FIG. 22 describes a third embodiment in which the lifting control part (LC) lifts the moving object (OJ) by applying pressure in a predetermined axial direction to the supporting part (SP). Hereinafter, the first embodiment is described in detail, and the second and third embodiments are described mainly with respect to differences from the first embodiment.

FIGS. 12 to 18 are diagrams illustrating an embodiment in which a lifting control part (LC) lifts a moving object (OJ) using a wire, according to some embodiments of the present disclosure.

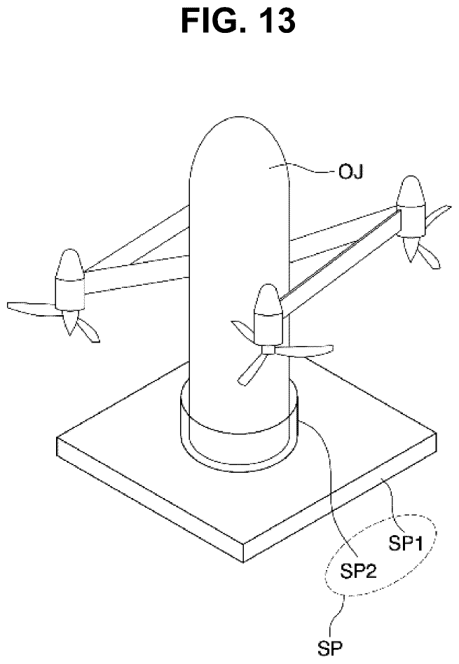

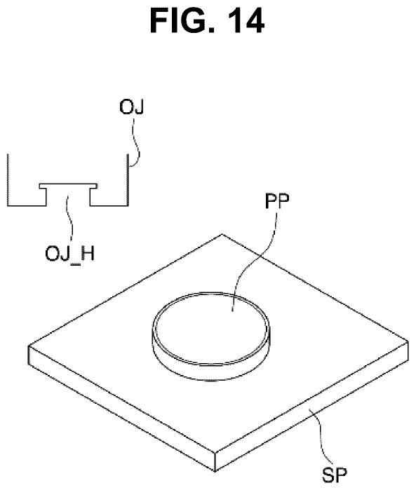

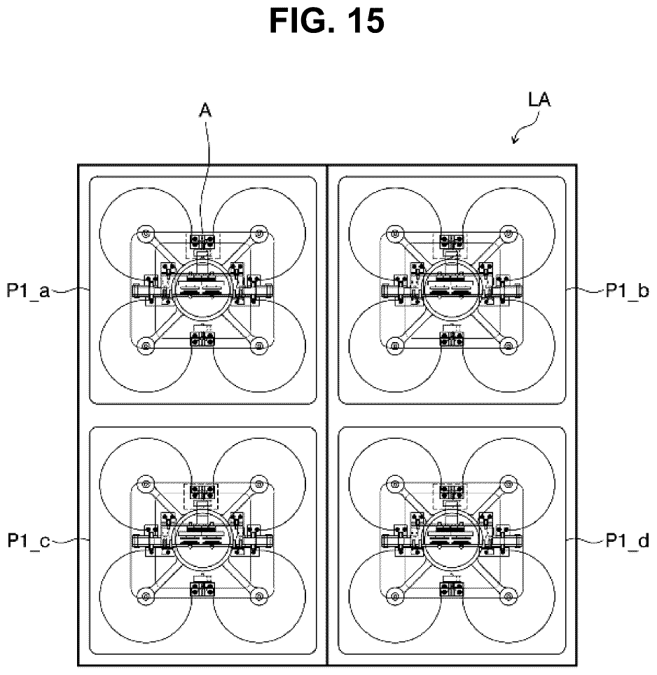

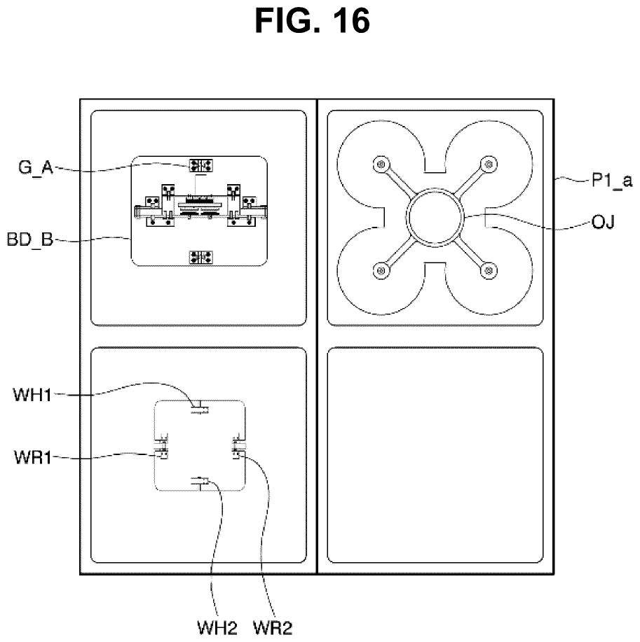

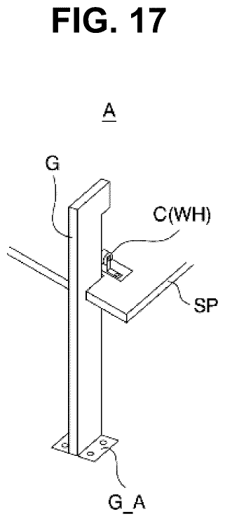

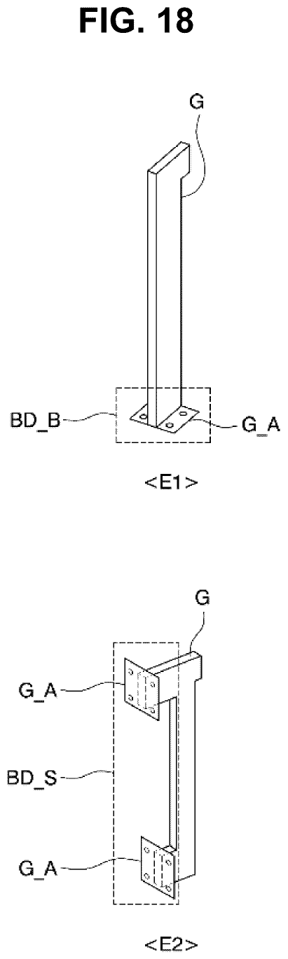

More specifically, FIG. 12 is a diagram illustrating how the lifting control part (LC) lifts the moving object (OJ) by controlling a wire (hereinafter, also referred to as “W”) to move a supporting part (SP). FIG. 13 is a diagram illustrating types of the supporting part according to some embodiments of the present disclosure. FIG. 14 is a diagram illustrating a protrusion part (PP) included in the supporting part according to some embodiments of the present disclosure. FIG. 15 is a top view of a launcher (LA) including a bottom of body (BD_B) of a body (BD), the supporting part (SP), and the moving object (OJ). FIG. 16 is a diagram illustrating a separated view of the bottom of body (BD_B), the supporting part (SP), and the moving object (OJ) for one of the plurality of sub-launchers (P1_a to P1_d) shown in FIG. 15, specifically for sub-launcher (P1_a). FIG. 17 is a diagram showing, from a different angle, the portion “A” of the first sub-launcher (P1_a) of FIG. 15, to illustrate that the supporting part (SP) moves along a guide part (G) via a wheel (WH), which is an example of a connect part (C). FIG. 18 is a diagram illustrating types of the guide part (G).

Here, <D1> of FIG. 12 illustrates a state in which the moving object (OJ) is on standby inside the launcher (LA), and <D2> of FIG. 12 illustrates a state after the moving object (OJ) has been lifted. In addition, here, for convenience of explanation, FIG. 17 illustrates an example in which the launcher (LA) includes one individual launcher, the individual launcher includes four sub-launchers (P1_a to P1_d), and accordingly, the launcher (LA) includes four bodies (BD) arranged in a 2×2 configuration. However, the present disclosure is not limited thereto, and the number of bodies (BD) included in the launcher (LA), that is, the number of sub-launchers (P1_a to P1_d), may be freely modified (e.g., 1×1, 3×3, etc.).

Referring to FIG. 1, FIG. 11, and FIGS. 12 to 18, a launcher (LA) according to some embodiments of the present disclosure may include a body (BD) and a supporting part (SP) that supports a moving object (OJ). Additionally, the launcher (LA) may further include a fan (F) and a handle part (H) formed between each body (BD). The handle part (H) may be a component for the user's portability.

The body (BD) may correspond to the concept of the sub-launchers (P1_a, P1_b) described in FIGS. 5 and 6, serving as a space that substantially accommodates the moving object (OJ) within the launcher (LA). FIG. 12 is a front view of the launcher (LA). For convenience of explanation, it illustrates an example in which the launcher (LA) includes two bodies (BD), and accordingly, each body (BD) includes a respective moving object (OJ). However, the number of bodies (BD) included in the launcher (LA), that is, the number of sub-launchers (P1_a, P1_b in FIGS. 5 and 6) may be freely varied (e.g., 1×1, 2×2, 3×3, etc.). For example, the body (BD) may include a bottom of body (BD_B) and a side of body (BD_S), as shown in FIG. 12. Meanwhile, the above-described actuator, fans (F1, F2), sensor, communication module (LAN port), processor (power S/W module), SMPS, and lifting control part (LC) may be embedded in the body (BD) or disposed on one side of the body (BD).

The supporting part (SP) may be configured to contact the moving object (OJ) and support the moving object (OJ). In some examples, the supporting part (SP) may be disposed below the moving object (OJ), as shown in FIG. 12, and may support the moving object (OJ) by contacting a lower surface of the moving object (OJ). For example, the supporting part (SP) may be disposed between the moving object (OJ) and the bottom of body (BD_B) of the body (BD), and may support the moving object (OJ) from below.

Here, as shown in FIG. 13, the supporting part (SP) may include at least one of a first supporting part (SP1) and a second supporting part (SP2). Although FIG. 13 illustrates the supporting part (SP) including both the first supporting part (SP1) and the second supporting part (SP2), this is merely for convenience of explanation, and either the first supporting part (SP1) or the second supporting part (SP2) may be omitted.

The first supporting part (SP1) may include a supporting part having a hexahedral shape. In other words, the shape of the first supporting part (SP1) may include a hexahedron. Here, the first supporting part (SP1) may have a rectangular parallelepiped shape, as shown in FIG. 13, but the embodiment of the present disclosure is not limited thereto.

The second supporting part (SP2) may include a supporting part having a cylindrical shape (e.g., a cup shape). In other words, the shape of the second supporting part (SP2) may include a cylinder. Here, the second supporting part (SP2) may have a hollow cup shape, as shown in FIG. 13, but the embodiment of the present disclosure is not limited thereto. Here, the second supporting part (SP2) may be disposed on an upper end of the first supporting part (SP1). In other words, the second supporting part (SP2) may be disposed between the moving object (OJ) and the first supporting part (SP1). Here, the second supporting part (SP2) may have a shape that supports the moving object (OJ) more firmly than the first supporting part (SP1), so that it may more securely support the posture of the moving object (OJ) when the moving object (OJ) takes off.

Meanwhile, as shown in FIG. 14, the supporting part (SP) according to some embodiments of the present disclosure may include a protrusion part (PP).

The protrusion part (PP) may have a shape configured to be inserted into a groove (OJ_H) formed on a lower portion of the moving object (OJ). In other words, a groove (OJ_H) may be formed on a lower portion of the moving object (OJ). Here, the protrusion part (PP) may have a shape corresponding to the groove (OJ_H), so that the protrusion part (PP) may be fitted into the groove (OJ_H).

Due to the shapes of the groove (OJ_H) and the protrusion part (PP), the supporting part (SP) may be more firmly coupled with the moving object (OJ). Here, during the takeoff process of the moving object (OJ), an impact may be applied to the protrusion part (PP) and the groove (OJ_H), and due to such impact, the moving object (OJ) may be unlocked from the protrusion part (PP). For example, as will be described below, the supporting part (SP) may ascend along a guide part (G in FIGS. 15, 19, and 22), and the guide part (G in FIGS. 15, 19, and 22) may include a blocking part of guide part (G_BP in FIG. 22) that prevents the ascent of the supporting part (SP). Here, if the supporting part (SP), while ascending, collides with the blocking part of guide part (G_BP in FIG. 22), the impact may cause the moving object (OJ) to be unlocked from the protrusion part (PP). However, in the present disclosure, the protrusion part (PP) may be omitted.

Meanwhile, the launcher (LA) may include a guide part (G) that guides the movement of the supporting part (SP), and the lifting control part (LC) may control the lifting of the moving object (OJ) by using the guide part (G). For example, the lifting control part (LC) may control a wire (W) structurally connected to the supporting part (SP), so that the supporting part (SP) moves along the guide part (G), thereby lifting the moving object (OJ).

More specifically, as illustrated in <D1> of FIG. 12, the lifting control part (LC) may apply pressure to the wire (W) in a predefined direction (the arrow direction in <D1> of FIG. 12). Accordingly, as shown in <D2> of FIG. 12, the supporting part (SP), which is structurally connected to the wire (W), may move upward inside the body (BD), thereby lifting the moving object (OJ). Here, the lifting control part (LC) may include a wire actuator for controlling the wire (W).

That is, the supporting part (SP) may move along the guide part (G) by the pressure applied to the wire (W). To this end, the supporting part (SP) may be physically connected to the wire (W) and the guide part (G).

For example, as shown in FIG. 16, the supporting part (SP) may include a wire receptor (WR) for connection to the wire (W), and a wheel (WH), which is an example of a connect part (C), for connection to the guide part (G). Here, the wheel (WH) may roll in the vertical direction along the guide part (G) by the pressure applied through the wire (W), as illustrated in FIG. 17.

A plurality of the wire receptors (WR) and wheels (WH) may be provided. In other words, the supporting part (SP) may include a plurality of wire receptors (WR) and a plurality of wheels (WH). For example, as shown in FIG. 16, the supporting part (SP) may include a first wire receptor (WR1), a second wire receptor (WR2), a first wheel (WH1), a second wheel (WH2), and the like.

Here, the first wire receptor (WR1), the second wire receptor (WR2), the first wheel (WH1), and the second wheel (WH2) may be arranged at different positions on the supporting part (SP). For example, on the supporting part (SP), the first wheel (WH1) and the second wheel (WH2) may be disposed at opposing positions, that is, facing each other. Similarly, the first wire receptor (WR1) and the second wire receptor (WR2) may be arranged at opposing positions, that is, facing each other. The plurality of wheels (WH1, WH2) and the plurality of wire receptors (WR1, WR2) may be alternately arranged at predefined angles with respect to the center of the supporting part (SP). Taking FIG. 16 as an example, the first wire receptor (WR1) may be disposed at the 9 o'clock position with respect to the center of the supporting part (SP), the first wheel (WH1) may be disposed at the 12 o'clock position with respect to the center of the supporting part (SP), the second wire receptor (WR2) may be disposed at the 3 o'clock position with respect to the center of the supporting part (SP), and the second wheel (WH2) may be disposed at the 6 o'clock position with respect to the center of the supporting part (SP). However, the embodiments of the present disclosure are not limited thereto.

In summary, when the lifting control part (LC) including the wire actuator controls the wire (W), the wire receptors (WR1, WR2) disposed at the 3 o'clock and 9 o'clock positions with respect to the center of the supporting part (SP) are pressed. As a result, the wheels (WH) disposed at the 12 o'clock and 6 o'clock positions with respect to the center of the supporting part (SP) roll along the guide part (G), and through this action, the supporting part (SP) moves, thereby lifting the moving object (OJ).

Meanwhile, although FIGS. 15 to 17 illustrate, for convenience of explanation, the guide part (G) as being attached to the bottom of body (BD_B) of the body (BD), the guide part (G) may also be attached to the side of body (BD_S) of the body (BD).

More specifically, the guide part (G) may include an attachment of guide part (G_A) for structural connection with the body (BD).

For example, as shown in <E1> of FIG. 18, the guide part (G) may be attached to the bottom of body (BD_B) of the body (BD). Here, the attachment of guide part (G_A) may connect the guide part (G) to the bottom of body (BD_B) of the body (BD).

As another example, the guide part (G) may be attached to the side of body (BD_S) of the body (BD), as shown in <E2> of FIG. 18. Here, the attachment of guide part (G_A) may connect the guide part (G) to the side of body (BD_S) of the body (BD). Here, as shown in <E2> of FIG. 18, when the guide part (G) is attached to the side of body (BD_S) of the body (BD), the number of attachments of guide part (G_A) may be plural. That is, when the guide part (G) is attached to the side of body (BD_S), the attachment force with the body (BD) may be weaker compared to when the guide part (G) is attached to the bottom of body (BD_B). To prevent this, when the guide part (G) is attached to the side of body (BD_S), it may be attached through a plurality of attachments of guide part (G_A).

Meanwhile, as described above, the guide part (G) may include a connect part (C) to be structurally connected to the supporting part (SP) in order to guide the vertical movement of the supporting part (SP). Here, the connect part (C) may include a wheel (WH in FIG. 17) that may roll along the guide part (G), and a connector (CN in FIG. 19) that is physically connected to the guide part (G). Here, the wheel (WH in FIG. 17) may be used in the control process according to the first embodiment of the lifting control part (LC), and the connector (CN in FIG. 19) may be used in the control process according to the second embodiment of the lifting control part (LC).

FIGS. 19 to 21 are diagrams for explaining embodiments in which the lifting control part (LC) lifts the moving object by transmitting a flight control signal to the moving object to control the generation of thrust of the moving object, according to several embodiments of the present disclosure.

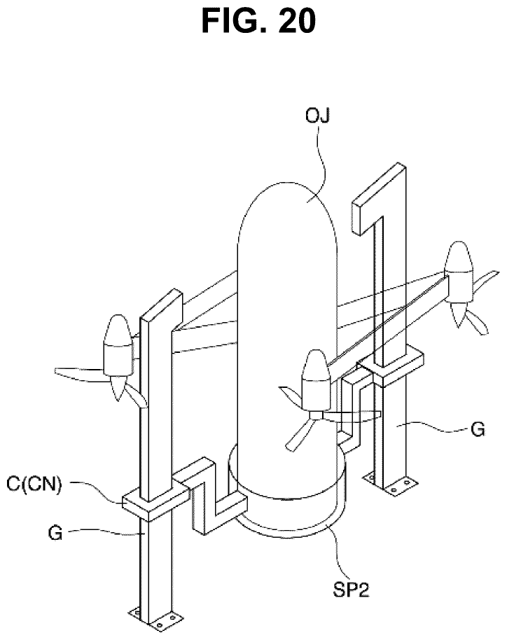

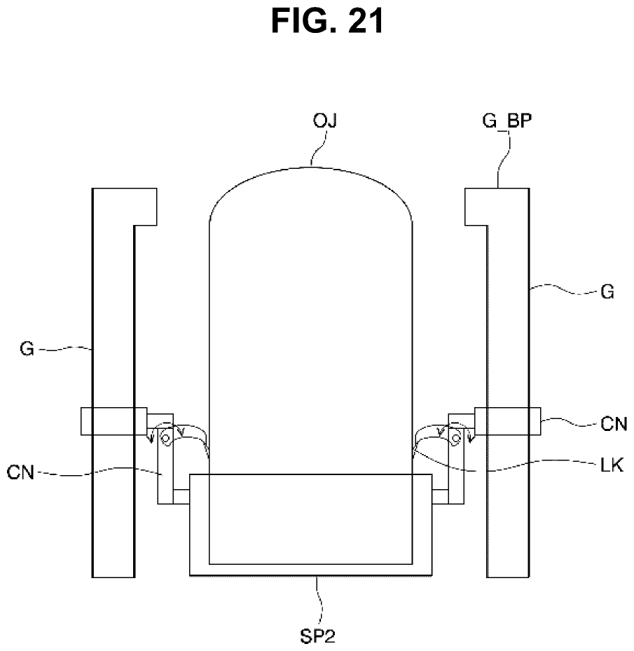

More specifically, FIG. 19 illustrates the operation of the lifting control part (LC) when the supporting part (SP) corresponds to the first supporting part (SP1) as described in FIG. 13, and FIG. 20 illustrates the operation of the lifting control part (LC) when the supporting part (SP) corresponds to the second supporting part (SP2) as described in FIG. 13. FIG. 21 is a view for explaining a connector (CN), which is an example of the connect part (C) included in the supporting part (SP), and a locker (LK) included in the connector (CN).

Referring to FIG. 1, FIG. 11, and FIGS. 19 to 21, the lifting control part (LC) may provide a flight control signal to the moving object (OJ), thereby generating thrust in the moving object (OJ), and accordingly, the supporting part (SP) in contact with the moving object (OJ) may move along the guide part (G), so that the moving object (OJ) may be lifted.

That is, while both the first embodiment and the second embodiment lift the moving object (OJ) using the guide part (G), the first embodiment moves the supporting part (SP) by using a wire (W) connected to the supporting part (SP), but the second embodiment differs in that it moves the supporting part (SP) by generating thrust in the moving object (OJ), which is positioned above the supporting part (SP), through the provision of a flight control signal to the moving object (OJ). However, the embodiment of the present disclosure is not limited thereto, and in the second embodiment, the flight control signal applied to the moving object (OJ) may also be provided by an external ground control system (GCS). Hereinafter, for the convenience of explanation, a case will be described in which the flight control signal is provided not by the external ground control system (GCS), but by the lifting control part (LC) of the launcher (LA).

More specifically, in some embodiments of the present disclosure, the lifting control part (LC) may provide a flight control signal to the moving object (OJ), so that the supporting part (SP) in contact with the moving object (OJ) moves along the guide part (G), thereby lifting the moving object (OJ). That is, the lifting control part (LC) may transmit a flight control signal to the motor included in the moving object (OJ) to generate power, and may control the moving object (OJ) to be lifted together with the supporting part (SP) through the force generated by the propeller of the moving object (OJ).

Here, as the supporting part (SP) moves along the guide part (G) under the control of the lifting control part (LC), the supporting part (SP) may need to be structurally connected to the guide part (G). To this end, the supporting part (SP) includes a connect part (C) to be connected with the guide part (G), and the connect part (C) may include a connector (CN).

The connector (CN) may serve to structurally connect the supporting part (SP) and the guide part (G), as illustrated in FIGS. 19 to 21. For example, one end of the connector (CN) may be attached to the supporting part (SP), and the other end may be attached to the guide part (G), so that the connector (CN) connects the supporting part (SP) and the guide part (G). Here, although the connector (CN) is illustrated as having a Korean letter “ [symbol] ” shaped form in FIGS. 19 to 21, it is understood that the shape and configuration of the connector (CN) are not limited thereto.

Such a connector (CN) may include a locker (LK), as illustrated in FIG. 21. Here, the locker (LK) may serve to structurally connect the supporting part (SP) and the moving object (OJ). For example, one end of the locker (LK) may be attached to the connector (CN), and the other end of the locker (LK) may be attached to the moving object (OJ), so that the locker (LK) may fix the moving object (OJ) to the supporting part (SP).

Here, the locker (LK) may release the locking between the supporting part (SP) and the moving object (OJ) in response to the elevation of the moving object (OJ) and the supporting part (SP).

For example, the guide part (G) may include a blocking part of guide part (G_BP) that prevents the supporting part (SP) from ascending beyond a predefined height. When the supporting part (SP) ascends and collides with the blocking part of guide part (G_BP), the locker (LK) may be designed to release the locking between the supporting part (SP) and the moving object (OJ). For example, when the supporting part (SP) collides with the blocking part of guide part (G_BP), the locker (LK) rotates outward as shown in FIG. 21, thereby releasing the locking between the moving object (OJ) and the supporting part (SP), and subsequently, the moving object (OJ) may take off. Here, the locker (LK) may be designed to be destroyed as the supporting part (SP) collides with the blocking part of guide part (G_BP), or may be designed to maintain the connection with the connector (CN) while releasing the connection with the moving object (OJ). Here, due to the impact caused by the collision between the supporting part (SP) and the blocking part of guide part (G_BP), the coupling between the protrusion part (PP) of the supporting part (SP) and the moving object (OJ) may also be unlocked.

As another example, as described above with reference to FIG. 11, the launcher (LA) may include a position sensor for identifying the position of the moving object (OJ) within the body (BD), and the locker (LK) may release the locking based on the position of the moving object as determined by the position sensor. For example, the lifting control part (LC) may receive the position of the moving object (OJ) from the position sensor, and if the received position of the moving object (OJ) is equal to or greater than a predefined height within the body (BD), the lifting control part (LC) may control the locker (LK) to release the locking between the moving object (OJ) and the supporting part (SP) for takeoff of the moving object (OJ).

Although FIGS. 19 to 21 illustrate an example in which the lifting control part (LC) provides a flight control signal to the moving object (OJ), the present disclosure is not limited thereto. For example, an external control system may directly provide a flight control signal to the moving object (OJ).

FIG. 22 is a diagram for illustrating an embodiment in which the lifting control part according to some embodiments of the present disclosure lifts the moving object by pressing the supporting part in a predetermined axial direction.

Referring to FIGS. 1, 11, and 22, the lifting control part (LC) according to some embodiments of the present disclosure may lift the moving object (OJ) by pressing the supporting part (SP) in a predetermined axial direction. In other words, the lifting control part (LC) may lift the moving object (OJ) by applying an external force directly to the supporting part (SP) to change the position of the supporting part (SP).

In some examples, the lifting control part (LC) may include a supporting part actuator that moves the supporting part (SP) in a predefined axial direction, and the moving object (OJ) may be lifted through this supporting part actuator.

That is, in the above-described first and second embodiments, the moving object (OJ) is lifted by allowing the supporting part (SP) to ascend along the guide part (G); but in the third embodiment, the lifting control part (LC) lifts the moving object (OJ) by moving the supporting part (SP) itself in multiple axial directions without using such a guide part (G).

Here, unlike what is shown in FIG. 22, the supporting part (SP) may be implemented as the second supporting part (SP2) instead of the first supporting part (SP1), and the protrusion part (PP) may be omitted.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. A launcher for lifting a moving object, comprising:
a body; and
a communication interface embedded in the body and configured to communicate with the moving object,
wherein, when the moving object is present inside the launcher, the communication interface is configured to control power supply to be blocked for some of a plurality of components included in the moving object by delivering a power control signal to a wireless switch included in the moving object.

2. The launcher of claim 1, wherein the moving object comprises an electronic speed control (ESC) for controlling a driving part comprising a motor or a propeller, and
wherein the communication interface provides a power cut-off signal, which turns off the wireless switch, to components other than the ESC.

3. The launcher of claim 1, wherein the moving object comprises a mission management unit (MMU), a flight control unit (FCU), a battery eliminator circuit (BEC), and a modem, and
wherein the communication interface provides a power cut-off signal, which turns off the wireless switch, to at least one of the MMU, FCU, BEC, and modem.

4. The launcher of claim 1, wherein the communication interface provides a power supply signal that turns on the wireless switch when the moving object is lifted from the launcher and is launched from the launcher.

5. The launcher of claim 1, wherein the body comprises a bottom of body and a side of body, and
wherein the launcher comprises:
a supporting part configured to be in contact with a lower side of the moving object to support the moving object from below; and
a lifting control part configured to lift the moving object by controlling at least one of the moving object and the supporting part.

6. The launcher of claim 5, wherein the supporting part comprises a protrusion part configured to fix the moving object to the supporting part by being inserted into a groove formed on a bottom of the moving object.

7. The launcher of claim 5, wherein the launcher further comprises a guide part configured to guide the supporting part to move vertically inside the launcher by being structurally connected to the supporting part.

8. The launcher of claim 7, wherein the guide part comprises an attachment part that is attached to at least one of a bottom of the body of the launcher and a side of the body of the launcher.

9. The launcher of claim 7, wherein the supporting part comprises a connect part that is structurally connected to the guide part.

10. The launcher of claim 9, wherein the lifting control part is configured to lift the moving object by controlling a wire structurally connected to the supporting part to move the supporting part along the guide part,
wherein the connect part comprises a wheel that is rollable along the guide part, and
wherein the supporting part further comprises a wire receptor configured to accommodate the wire.

11. The launcher of claim 10, wherein the wheel comprises a plurality of wheels comprising a first wheel and a second wheel, and
wherein the wire receptor comprises a plurality of wire receptors comprising a first wire receptor and a second wire receptor.

12. The launcher of claim 11, wherein each of the first wheel, the second wheel, the first wire receptor, and the second wire receptor is disposed at a different position on the supporting part.

13. The launcher of claim 12, wherein the first wheel and the second wheel are disposed at positions facing each other on the supporting part,
wherein the first wire receptor and the second wire receptor are disposed at positions facing each other on the supporting part, and
wherein the plurality of wheels and the plurality of wire receptors are alternately arranged at predefined angles with respect to a center of the supporting part.

14. The launcher of claim 9, wherein the lifting control part generates thrust in the moving object by providing a flight control signal to the moving object, and lifts the moving object by causing the supporting part in contact with the moving object to move along the guide part, and
wherein the connect part comprises a connector that is structurally connected to the guide part.

15. The launcher of claim 14, wherein the connector comprises a locker that locks the moving object to the supporting part by being structurally connected to the moving object.

16. The launcher of claim 15, wherein the guide part comprises a blocking part that prevents the supporting part from ascending beyond a predefined height, and
wherein, when the supporting part collides with the blocking part, the locker releases the locking of the moving object.

17. The launcher of claim 15, wherein the launcher further comprises a position sensor configured to determine a position of the moving object inside the launcher, and
wherein the lifting control part controls the locker to release the locking based on the position of the moving object determined by the position sensor.

18. The launcher of claim 5, wherein the lifting control part lifts the moving object by applying an external force to the supporting part itself to change the position of the supporting part.

19. The launcher of claim 18, wherein the lifting control part comprises an actuator that changes the position of the supporting part in a direction of at least one axis.
